(19) United States
(12) Patent Application Publication
(10) Pub. No.: US 2015/0338203 A1
(43) Pub. Date: Nov. 26, 2015

(54) MEASUREMENT SYSTEM, METHOD FOR MEASUREMENT

(71) Applicant: KABUSHIKI KAISHA YASKAWA DENKI, Kitakyushu-shi (JP)

(72) Inventor: Yuji ICHIMARU, Kitakyushu-shi (JP)

(73) Assignee: KABUSHIKI KAISHA YASKAWA DENKI, Kitakyushu-shi (JP)

(21) Appl. No.: 14/718,007

(22) Filed: May 20, 2015

(30) Foreign Application Priority Data
May 21, 2014 (JP) 2014-105045

(51) Int. Cl. G01B 11/00; G01B 11/26

(52) U.S. Cl. CPC G01B 11/002; G01B 11/26

(57) ABSTRACT

A measurement system includes an irradiator, an image capturer, and an arithmetic processor. The irradiator irradiates a first irradiation line with a laser beam at a first irradiation angle, and irradiates second irradiation lines with the laser beam respectively at second irradiation angles. The second irradiation lines intersect the first irradiation line. The image capturer acquires a two-dimensional image of an area including the first irradiation line and the second irradiation lines. The arithmetic processor calculates the second irradiation angles based on the first irradiation angle, based on a first position, in the two-dimensional image, of a first point on the first irradiation line, and based on second positions, in the two-dimensional image, of second points of the second irradiation lines, and calculates three-dimensional coordinates of the second points based on the second irradiation angles and the second positions.

### CROSS-REFERENCE TO RELATED APPLICATIONS

The present application claims priority under 35 U.S.C. §119 to Japanese Patent Application No. 2014-105045, filed May 21, 2014. The contents of this application are incorporated herein by reference in their entirety.

### BACKGROUND

1. Field of the Invention

The embodiments disclosed herein relate to a measurement system and a method for measurement.

2. Discussion of the Background

Japanese Unexamined Patent Application Publication No. 2000-161935 discloses a method for three-dimensional coordinate measurement. The method includes irradiating a measured object with slit light, capturing a two-dimensional image of the measured object using a camera, and based on the coordinates of the irradiated portion of the measured object on the two-dimensional image, calculating three-dimensional coordinates of the irradiated portion of the measured object.

According to one aspect of the present disclosure, a measurement system includes an irradiator, an image capturer, and an arithmetic processor. The irradiator is configured to irradiate a first irradiation line with a laser beam at a predetermined first irradiation angle, and is configured to irradiate a plurality of second irradiation lines with the laser beam respectively at a plurality of second irradiation angles. The plurality of second irradiation lines intersect the predetermined first irradiation line. The image capturer is configured to acquire a two-dimensional image of an area including the predetermined first irradiation line and the plurality of second irradiation lines. The arithmetic processor is configured to calculate the plurality of second irradiation angles based on the first irradiation angle, based on a first position, in the two-dimensional image, of a first point on the predetermined first irradiation line, and based on second positions, in the two-dimensional image, of second points of the plurality of second irradiation lines, and is configured to calculate three-dimensional coordinates of the second points based on the plurality of second irradiation angles and based on the second positions.

According to another aspect of the present disclosure, a measurement system includes an irradiator, an image capturer, and an arithmetic processor. The irradiator is configured to emit a laser beam. The image capturer is configured to acquire a two-dimensional image of a first area including a first irradiation spot made by the laser beam. The arithmetic processor is configured to calculate three-dimensional coordinates of the first irradiation spot based on known information and information acquired from the two-dimensional image.

According to the other aspect of the present disclosure, a method for measurement includes irradiating a first irradiation line with a laser beam at a predetermined first irradiation angle and irradiating a plurality of second irradiation lines with the laser beam respectively at a plurality of second irradiation angles. The plurality of second irradiation lines intersect the predetermined first irradiation line. A two-dimensional image of an area including the predetermined first irradiation line and the plurality of second irradiation lines is acquired. The plurality of second irradiation angles are calculated based on the first irradiation angle, based on a first position, in the two-dimensional image, of a first point on the predetermined first irradiation line, and based on second positions, in the two-dimensional image, of second points of the plurality of second irradiation lines, and three-dimensional coordinates of the second points are calculated based on the plurality of second irradiation angles and based on the second positions.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a diagram illustrating a measurement system;

FIG. 2 is a plan view of the measurement system;

FIG. 3 is a side view of the measurement system taken along the line illustrated in FIG. 2;

FIG. 4 is a side view of the measurement system taken along the line IV-IV illustrated in FIG. 2;

FIG. 5 is a perspective view of an irradiator illustrating its configuration;

FIG. 6 is a block diagram illustrating a hardware configuration of a controller;

FIG. 7 is a flowchart of a procedure for a method for measurement;

FIG. 8 is a flowchart of a procedure for the method for measurement;

FIG. 9 is a plan view of the measurement system, illustrating a procedure for irradiation of a plurality of first irradiation lines with a laser beam;

FIG. 10 is a plan view of the measurement system, illustrating a procedure for irradiation of a plurality of second irradiation lines with a laser beam;

FIG. 11 is a diagram illustrating an exemplary arrangement of the irradiator and an image capturer;

FIG. 12 is a diagram illustrating another exemplary arrangement of the irradiator and the image capturer;

FIG. 13 is a diagram illustrating still another exemplary arrangement of the irradiator and the image capturer;

FIG. 14 is a plan view of a modification of the measurement system;

FIG. 15 is a side view of the measurement system taken along the line XV-XV illustrated in FIG. 14;

FIG. 16 is a side view of the measurement system taken along the line XVI-XVI illustrated in FIG. 14;

FIG. 17 is a plan view of another modification of the measurement system;

FIG. 18 is a plan view of still another modification of the measurement system; and

FIG. 19 is a side view of the measurement system illustrated in FIG. 18.

### DESCRIPTION OF THE EMBODIMENTS

Embodiments will now be described in detail with reference to the accompanying drawings, wherein like reference numerals designate corresponding or identical elements throughout the various drawings. For convenience of description, each of the drawings is provided with an indication of an xyz rectangular coordinate system having a vertically upward direction being the positive direction of z axis.

A measurement system 1 according to this embodiment irradiates a measurement measured object with a laser beam, acquires a two-dimensional image of an area including the irradiated portion of the measured object, and performs three-dimensional measurement of the surface of the measured object using the principle of triangulation. Description will be made with regard to an outline of a configuration of the measurement system 1, configuration details of the components of the measurement system 1, procedures for control processing and arithmetic processing, advantageous effects of the measurement system 1, and modifications of the measurement system 1.

### 1. Outline of Configuration of Measurement System

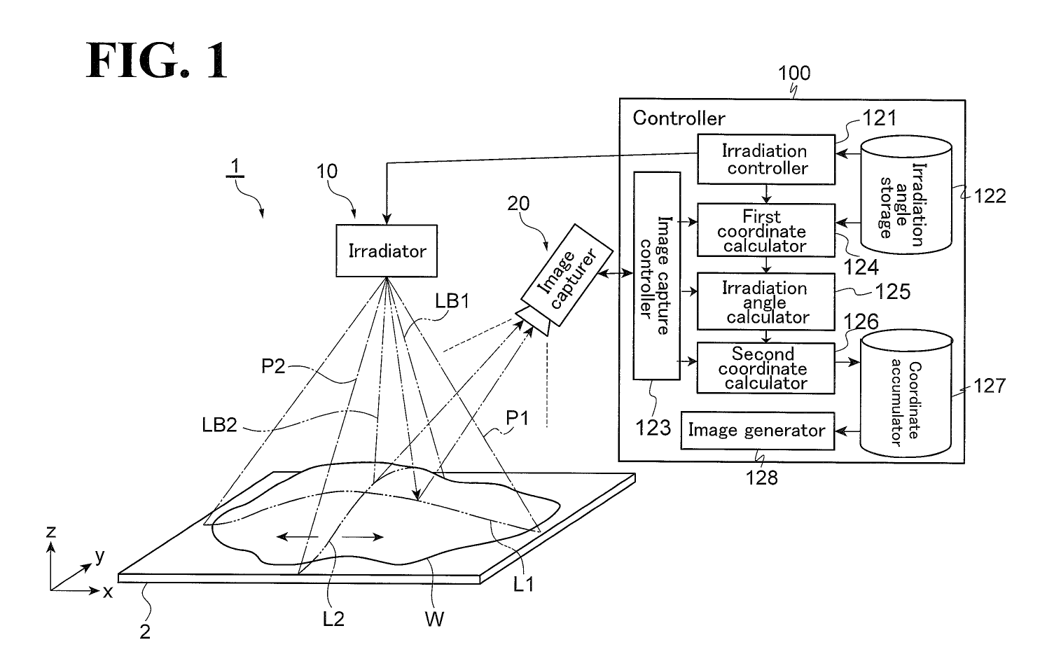

As illustrated in FIG. 1, the measurement system 1 includes a measurement base 2, an irradiator 10, an image capturer 20, and a controller 100.

The measurement base 2 has a horizontal surface on which a measured object W is placed to be measured by the measurement system 1. The irradiator 10 is disposed above the measurement base 2 and emits a laser beam. The image capturer 20 is disposed above the measurement base 2 at a distance from the irradiator 10, and acquires a two-dimensional image.

The controller 100 includes an irradiation controller 121, an irradiation angle storage 122, an image capture controller 123, a first coordinate calculator 124, an irradiation angle calculator 125, a second coordinate calculator 126, a coordinate accumulator 127, and an image generator 128.

The irradiation controller 121 controls the irradiator 10 to irradiate a plurality of first irradiation lines L1 with a laser beam LB1 respectively at a plurality of predetermined first irradiation angles θ1. The irradiation controller 121 also controls the irradiator 10 to irradiate a plurality of second irradiation lines L2, which intersect the first irradiation lines L1, with a laser beam LB2 respectively at a plurality of second irradiation angles θ2. Thus, the irradiation controller 121 assumes some of the functions of the irradiator 10. That is, with the irradiation controller 121, the irradiator 10 irradiates the first irradiation lines L1 with the laser beam LB1 respectively at the predetermined first irradiation angles θ1, and irradiates the plurality of second irradiation lines L2, which intersect the first irradiation lines L1, with the laser beam LB2 respectively at the plurality of second irradiation angles θ2.

The irradiation angle storage 122 stores the plurality of first irradiation angles θ1.

The image capture controller 123 controls the image capturer 20 to acquire a two-dimensional image of an area R1. The area R1 includes the first irradiation lines L1 and the second irradiation lines L2. Thus, the image capture controller 123 assumes some of the functions of the image capturer 20. That is, with the image capture controller 123, the image capturer 20 acquires a two-dimensional image of the area R1, which includes the first irradiation lines L1 and the second irradiation lines L2.

Based on the plurality of first irradiation angles θ1 and based on the positions, in the two-dimensional image, of points on the plurality of first irradiation lines L1, the first coordinate calculator 124 calculates three-dimensional coordinates of the points on the plurality of first irradiation lines L1. The positions will be hereinafter referred to as “two-dimensional coordinates”.

Based on two-dimensional coordinates of intersection points at which the plurality of second irradiation lines L2 intersect at least one first irradiation line L1 among the plurality of first irradiation lines LL the irradiation angle calculator 125 identifies three-dimensional coordinates of the intersection points. Based on the three-dimensional coordinates of the intersection points, the irradiation angle calculator 125 calculates a plurality of second irradiation angles θ2.

Based on the plurality of second irradiation angles θ2 and two-dimensional coordinates of points on the plurality of second irradiation lines L2, the second coordinate calculator 126 calculates three-dimensional coordinates of the points on the plurality of second irradiation lines L2.

The coordinate accumulator 127 accumulates the three-dimensional coordinates calculated by the second coordinate calculator 126. The three-dimensional coordinates accumulated in the coordinate accumulator 127 are applicable as data indicating a surface shape of the measured object W.

Based on the data accumulated in the coordinate accumulator 127, the image generator 128 generates an image of the surface shape of the measured object W.

With this configuration, the controller 100 functions as a controller of the irradiator 10 and the image capturer 20, and also functions as an arithmetic processor to calculate three-dimensional coordinates. As the arithmetic processor, the controller 100 calculates the plurality of second irradiation angles θ2 based on the first irradiation angles θ1, based on the positions, in the two-dimensional image, of points on the first irradiation lines L1, and based on the positions, in the two-dimensional image, of points on the second irradiation lines L2. For convenience of description, the components or functions of the controller 100 are illustrated in FIG. 1 in blocks (hereinafter referred to as “function blocks”). The function blocks, however, may not necessarily represent the actual hardware.

### 2. Configuration Details of Components

Next, configurations of the irradiator 10, the image capturer 20, and the controller 100 will be described in more detail.

### (1) Irradiator

(1-1) Function of Irradiating First Irradiation Lines with Laser Beam

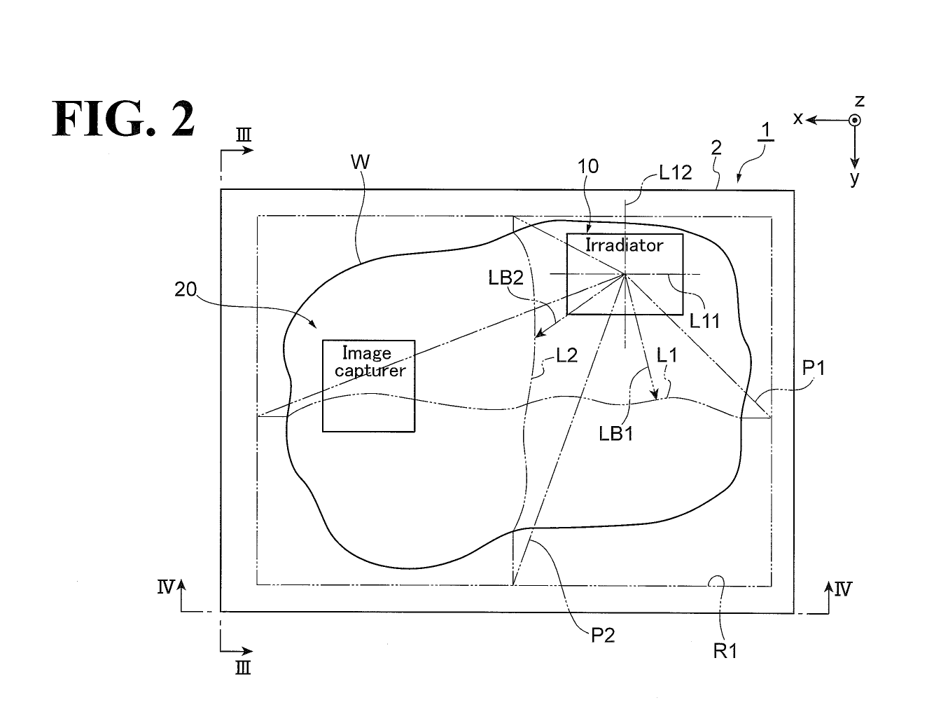

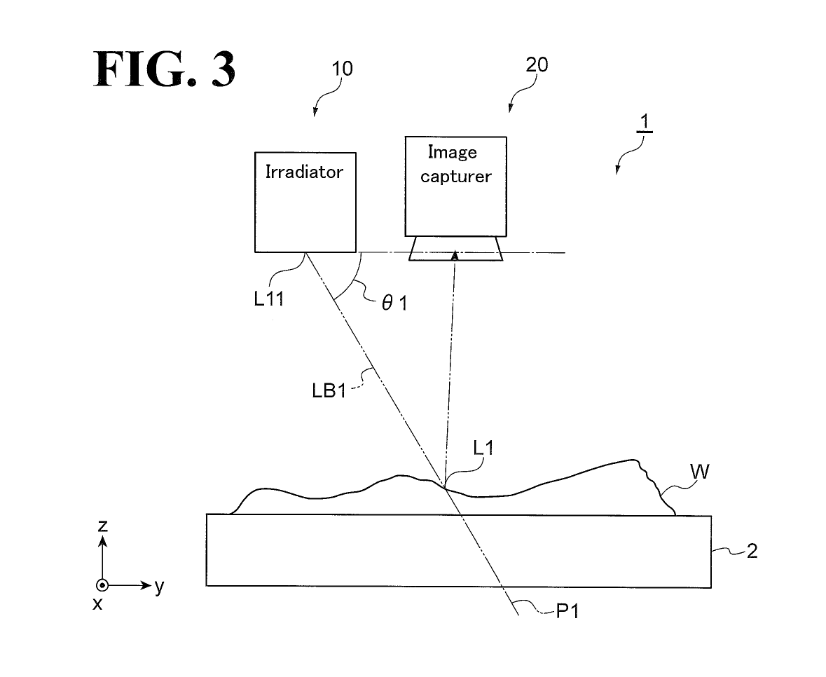

As illustrated in FIGS. 2 and 3, the irradiator 10 emits a laser beam LB1 toward a measured object Win an optical path along a first plane P1, and radiates the laser beam LB1 to an intersection line over which the first plane P1 intersects the surface of the measured object W. The first irradiation angle θ1 is an inclination angle of the first plane P1. The first irradiation line L1 is the intersection line over which the first plane P1 intersects the surface of the measured object W.

It is noted that the inclination angle of the first plane P1 is an angle around an intersection line (hereinafter referred to as “first axis L11”) over which the first plane P1 intersects a horizontal plane. For convenience of description, the first axis L11 is parallel to the x axis. While in this embodiment the inclination angle of the first plane P1 is based on a horizontal plane, this should not be construed in a limiting sense. Another possible embodiment is that the inclination angle of the first plane P1 is based on a vertical line, insofar as the angle around the first axis L1 is known.

(1-2) Function of Irradiating Second Irradiation Lines with Laser Beam

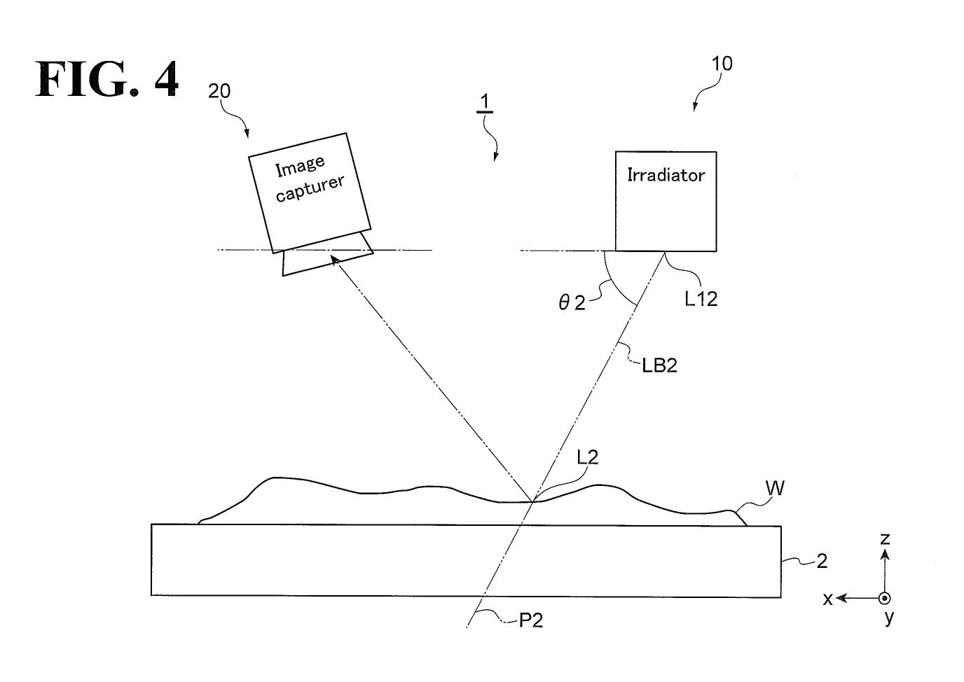

As illustrated in FIGS. 2 and 4, the irradiator 10 emits a laser beam LB2 toward the measured object W in an optical path along a second plane P2, and radiates the laser beam LB2 to an intersection line over which the second plane P2 intersects the surface of the measured object W. The second irradiation angle θ2 is an inclination angle of the second plane P2. The second irradiation line L2 is the intersection line over which the second plane P2 intersects the surface of the measured object W.

It is noted that the inclination angle of the second plane P2 is an angle around an intersection line (hereinafter referred to as “second axis L12”) over which the second plane P2 intersects the horizontal plane. For convenience of description, the second axis L12 is parallel to the y axis and orthogonal to the first axis L11. While in this embodiment the inclination angle of the second plane P2 is based on a horizontal plane, this should not be construed in a limiting sense. Another possible embodiment is that the inclination angle of the second plane P2 is based on a vertical line, insofar as the angle around the second axis L12 is already known. Also, insofar as the second axis L12 and the first axis L11 intersect each other, the second axis 12 and the first axis L11 may not necessarily be orthogonal to each other.

### (1-3) Specific Example of Irradiator

The irradiator 10 may be implemented in various configurations. A non-limiting embodiment is use of a Micro Electro Mechanical Systems (MEMS) mirror 41, which will be described below.

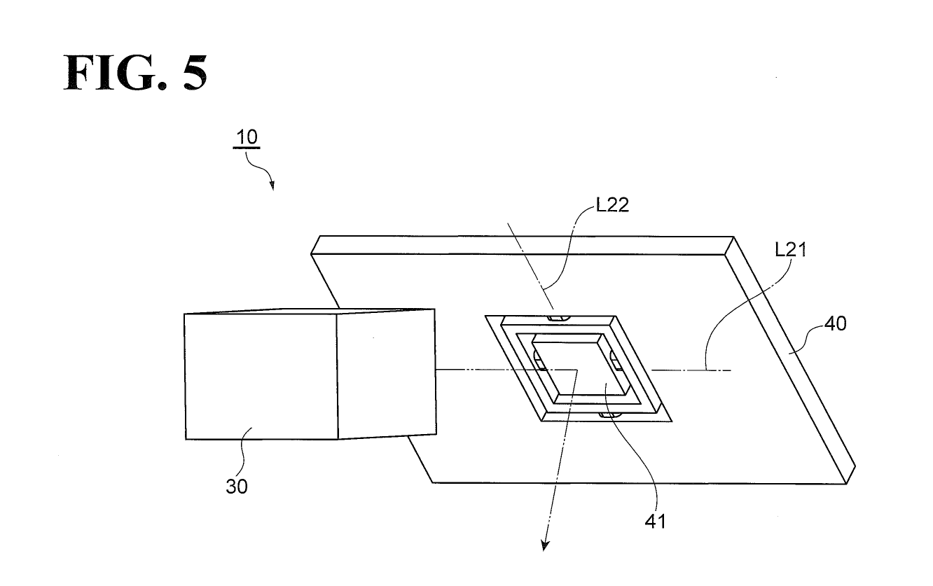

As illustrated in FIG. 5, the irradiator 10 includes a light source 30 and the MEMS mirror 41. A non-limiting embodiment of the light source 30 is a semiconductor laser. The light source 30 emits a spotted laser beam. The MEMS mirror 41 is arranged at a position to reflect the laser beam emitted from the light source 30. The MEMS mirror 41 is disposed on an electronic circuit substrate 40 in a rotatable manner about axes L21 and L22. Examples of the electronic circuit substrate 40 include, but are not limited to, a silicon substrate and a glass substrate. On the electronic circuit substrate 40, an actuator is disposed to turn the MEMS mirror 41 about the axes L21 and L22. As used herein, the “MEMS mirror” refers to the mirror arranged on the electronic circuit substrate 40 together with the actuator.

The irradiation controller 121 controls the MEMS mirror 41 to turn about the axes L21 and L22. Specifically, the irradiation controller 121 turns the MEMS mirror 41 to irradiate the plurality of first irradiation lines L1 with the laser beam LB1, which has been reflected by the MEMS mirror 41, at the plurality of first irradiation angles θ1 stored in the irradiation angle storage 122. Here, the irradiation controller 121 turns the MEMS mirror 41 to move an irradiation spot made by the laser beam LB1 along the plurality of first irradiation lines L1. The irradiation controller 121 turns the MEMS mirror 41 to irradiate the plurality of second irradiation lines L2 with the laser beam LB2, which has been reflected by the MEMS mirror 41, at the plurality of second irradiation angles θ2. Here, the irradiation controller 121 turns the MEMS mirror 41 to move an irradiation spot made by the laser beam LB2 along the plurality of second irradiation lines L2.

### (2) Image Capturer

The image capturer 20 incorporates an image capture device such as a Charge Coupled Device (CCD) and a Complementary Metal-Oxide Semiconductor (CMOS). The image capture controller 123 controls the image capturer 20 to repeat, for each constant frame period, a cycle of exposure by the image capture device and reading of a two-dimensional image from the image capture device. In this manner, the image capture controller 123 acquires a two-dimensional image for each frame period.

### (3) Controller

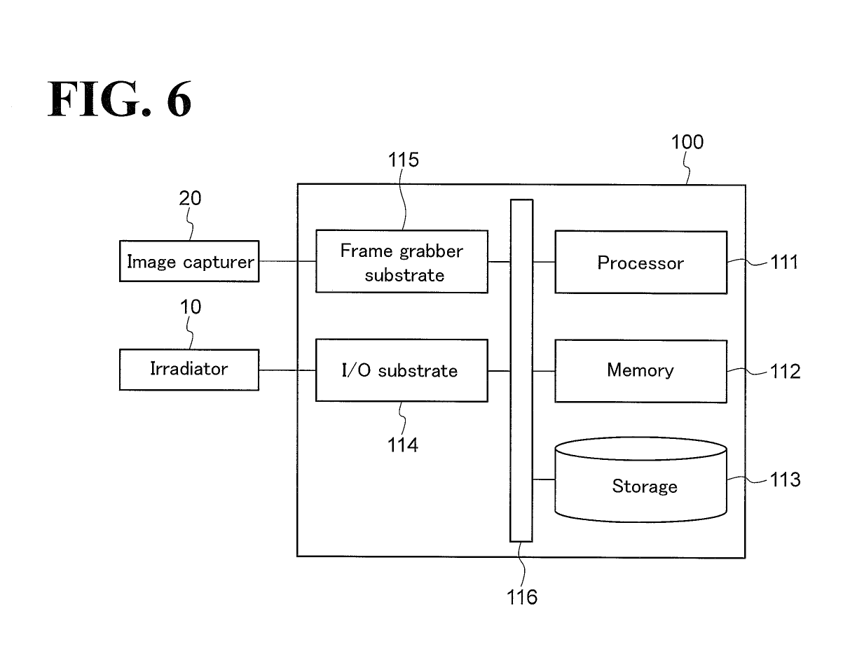

FIG. 6 illustrates a configuration of the controller 100 on hardware. As illustrated in FIG. 6, the controller 100 includes a processor 111, a memory 112, a storage 113, an input-output substrate 114, a frame grabber substrate 115, and buses 116. The buses 116 connect these components to each other. The input-output substrate 114 inputs and outputs data for controlling the irradiator 10. The frame grabber substrate 115 inputs and outputs data for controlling the image capturer 20, and inputs and outputs image data. The processor 111 cooperates with at least one of the memory 112 and the storage 113 to execute a program so as to input and output data through the input-output substrate 114 and the frame grabber substrate 115. Thus, the various functions of the controller 100 are implemented.

The configuration illustrated in FIG. 6 is provided for exemplary purposes, and be controller 100 may have any other configuration on hardware insofar as the various functions are implemented. For example, it is not necessary to implement each function of the controller 100 by executing a program. Instead, each function may be implemented using a circuit element (such as a logical IC) specializing in a predetermined operation.

### 3. Control and Arithmetic Processing Procedures

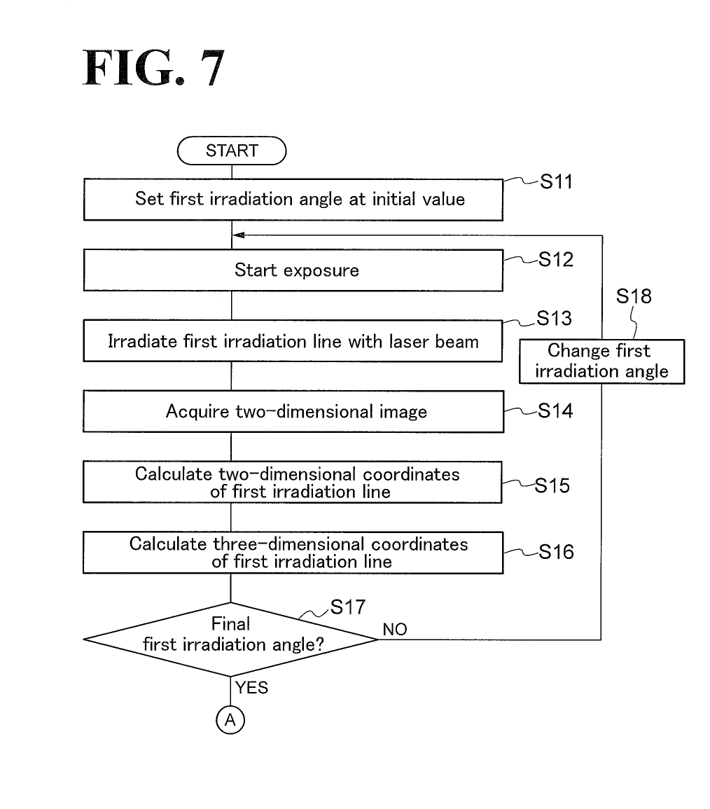

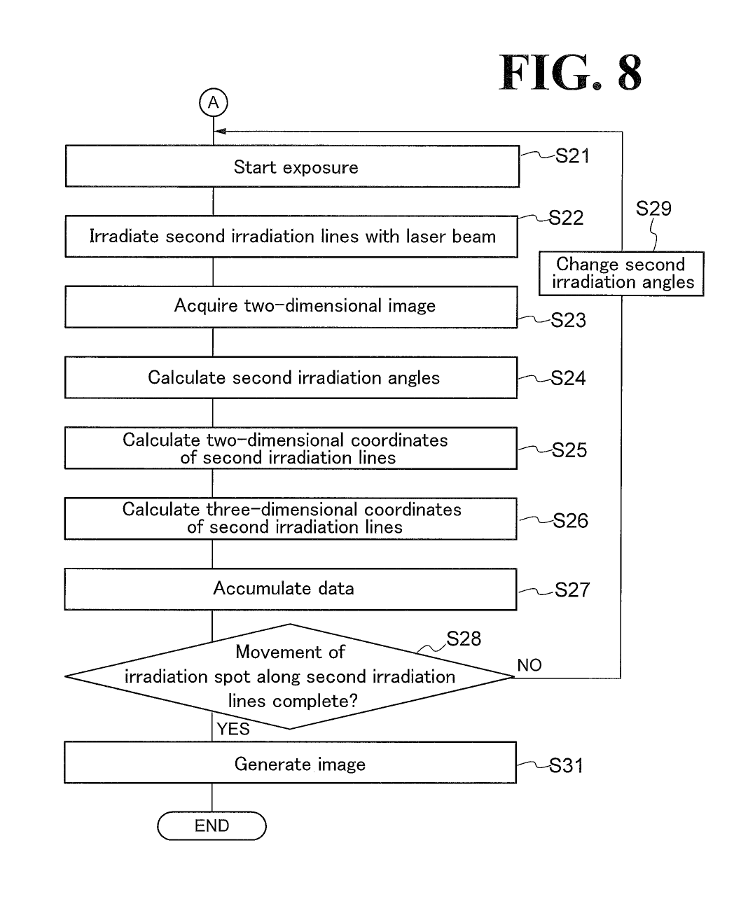

Next, exemplary procedures for control and arithmetic processing performed by the controller 100 will be described. Through the procedures illustrated in FIGS. 7 and 8, the controller 100 controls the irradiator 10 and the image capturer 20, performs arithmetic processing and accumulation of three-dimensional coordinates, and generates an image of a surface of a measured object W. Thus, the method for measurement according to this embodiment is performed.

First, the controller 100 performs step S11 illustrated in FIG. 7. At step S11, the irradiation controller 121 sets the first irradiation angle θ1 at a predetermined initial value. The initial value may be any of the plurality of first irradiation angles θ1 stored in the irradiation angle storage 122. In this embodiment, the initial value is the minimum irradiation angle of the plurality of first irradiation angles θ1 stored in the irradiation angle storage 122.

Next, the controller 100 successively performs steps S12 to S14. At step S12, the image capture controller 123 controls the image capturer 20 to start exposure by the image capture device. At step S13, the irradiation controller 121 controls the MEMS mirror 41 to irradiate the first irradiation lines L1 with the laser beam LB1 at the first irradiation angle θ1. Here, the irradiation controller 121 controls the MEMS mirror 41 to move the irradiation spot made by the laser beam LB1 along the first irradiation lines L1. At step S14, the image capture controller 123 controls the image capturer 20 to read an image from the image capture device, and acquires a two-dimensional image.

Next, the controller 100 successively performs steps S15 and S16. At step S15, the first coordinate calculator 124 performs image processing to calculate two-dimensional coordinates of each point on the first irradiation lines L1 in the two-dimensional image. At step S16, based on the first irradiation angle θ1 and the two-dimensional coordinates of each point on the first irradiation lines L1, the first coordinate calculator 124 calculates three-dimensional coordinates of each point on the first irradiation lines L1.

Based on the principle of triangulation, the first coordinate calculator 124 calculates three-dimensional coordinates X, Y, and Z from, for example, the following Formulae (1) and (2). In Formula (1), h_{A} is a parameter, and a₁₁ to a₃₄ are constants. Constants a₁₁ to a₃₄ are determined in accordance with the position of the image capturer 20 and optical properties of the image capturer 20, among other factors. In Formula (2), h_{B} is a parameter, and b₁₁ to b₂₄ are constants. Constants b₁₁ to b₂₄ are determined in accordance with the position of the light source 30 and the position of the MEMS mirror 41, among other factors. Constants a₁₁ to a₃₄ and b₁₁ to b₂₄ may be set in advance by a known method of calibration (see, for example, Japanese Examined Patent Publication No. 6-6374). The three-dimensional coordinates X, Y, and Z are calculated by solving simultaneous equations including an equation acquired by substituting two-dimensional coordinates u and v into Formula (1), and an equation acquired by substituting the first irradiation angle θ1 into Formula (2).

$$\begin{matrix}( \begin{matrix}{h}_{A} \cdot u \\ {h}_{A} \cdot v \\ {h}_{A}\end{matrix} ) = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34}\end{matrix} ) ( \begin{matrix}X \\ Y \\ Z \\ 1\end{matrix} ) & Formula 1 \\ ( \begin{matrix}{h}_{B} \cdot θ 1 \\ {h}_{B}\end{matrix} ) = ( \begin{matrix}{b}_{11} & {b}_{12} & {b}_{13} & {b}_{14} \\ {b}_{21} & {b}_{22} & {b}_{23} & {b}_{24}\end{matrix} ) ( \begin{matrix}X \\ Y \\ Z \\ 1\end{matrix} ) & Formula 2\end{matrix}$$

Next, the controller 100 performs step S17. At step S17, the irradiation controller 121 confirms whether the first irradiation angle θ1 is a final value. The final value may be any of the plurality of first irradiation angles θ1 stored in the irradiation angle storage 122. In this embodiment, the final value is the maximum irradiation angle of the plurality of first irradiation angles θ1 stored in the irradiation angle storage 122.

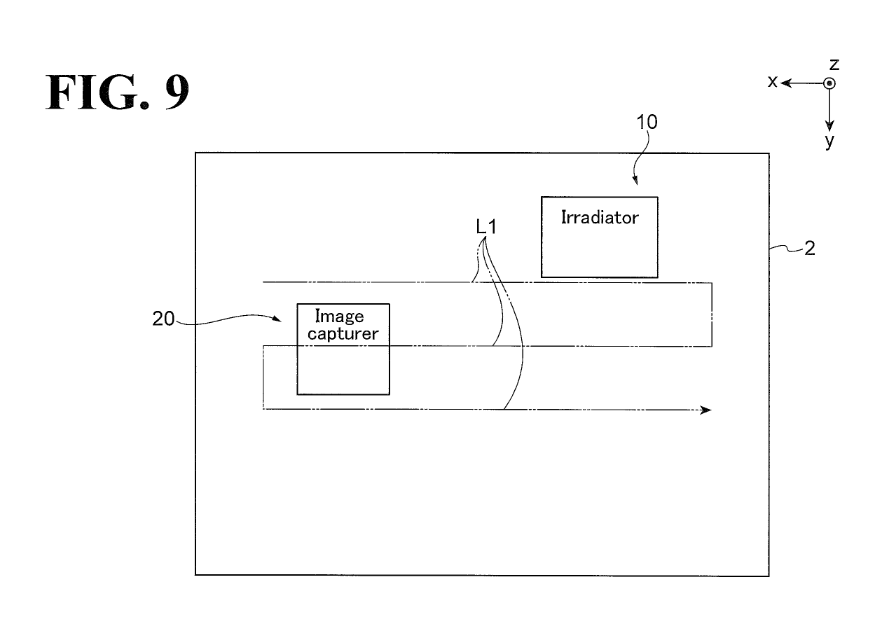

When the first irradiation angle θ1 is not the final value, the controller 100 performs step S18. At step S18, the irradiation controller 121 changes the first irradiation angle θ1 to a next value. The “next value” may be any value among the plurality of first irradiation angles θ1 stored in the irradiation angle storage 122 insofar as the value has not been used. In this embodiment, the “next value” is the second largest value among the plurality of first irradiation angles θ1 stored in the irradiation angle storage 122 next to the current first irradiation angle θ1. After changing the first irradiation angle θ1, the controller 100 returns the processing to step S11 and repeats steps S11 to S18 until the first irradiation angle θ1 becomes the final value. Thus, the plurality of first irradiation lines L1 are irradiated with the laser beam at the plurality of first irradiation angles θ1 (see FIG. 9), and three-dimensional coordinates of irradiation spots are calculated. The controller 100 may repeat steps S11 to S18 for each frame period described above.

Thus, the method for measurement according to this embodiment includes: irradiating the plurality of first irradiation lines L1 with the laser beam respectively at the plurality of predetermined first irradiation angles θ1; and calculating three-dimensional coordinates of points on the plurality of first irradiation lines L1.

When at step S17 the irradiation controller 121 confirms that the first irradiation angle θ1 is the final value, the controller 100 performs steps S21 to S23 illustrated in FIG. 8. At step S21, the image capture controller 123 controls the image capturer 20 to start exposure by the image capture device. At step S22, the irradiation controller 121 controls the MEMS mirror 41 to irradiate the second irradiation lines L2 with the laser beam LB2 at the second irradiation angles θ2. Here, the irradiation controller 121 controls the MEMS mirror 41 to move an irradiation spot made by the laser beam LB2 along the second irradiation lines L2. At step S23, the image capture controller 123 controls the image capturer 20 to read an image from the image capture device so as to acquire a two-dimensional image.

Next, the controller 100 performs step S24. At step S24, based on two-dimensional coordinates of intersection points at which the second irradiation lines L2 intersect at least one first irradiation line L1 among the plurality of first irradiation lines L1, the irradiation angle calculator 125 identifies three-dimensional coordinates of the intersection points. Based on the three-dimensional coordinates of the intersection points, the irradiation angle calculator 125 calculates the second irradiation angles θ2. Since a two-dimensional image is made up of a finite number of pixels, the second irradiation lines L2 and the first irradiation lines L1 in the two-dimensional image are combinations of a finite number of points in a strict sense. This makes it possible that any of the intersection points is situated between the points constituting the first irradiation line L1. It is also possible that any of the intersection points is situated between the points constituting the second irradiation line L2. In these possibilities, linear interpolation or similar processing may be performed to fill in at least the gaps between the points constituting the first irradiation line L1 or the gaps between the points constituting the second irradiation line L2. In this manner, the two-dimensional coordinates and the three-dimensional coordinates of the intersection points may be calculated.

The irradiation angle calculator 125 calculates the second irradiation angles θ2 based on the following Formula (3), for example. In Formula (3), hp is a parameter, and d₁₁ to d₂₄ are constants. Constants d₁₁ to d₂₄ are determined in accordance with the position of the light source 30 and the position of the MEMS mirror 41, among other factors. Constants d₁₁ to d₂₄ may be set in advance by a known method of calibration. The second irradiation angles θ2 are calculated by substituting the three-dimensional coordinates X, Y, and Z of the intersection point into Formula (3).

$$( \begin{matrix}{h}_{D} \cdot θ 2 \\ {h}_{D}\end{matrix} ) = ( \begin{matrix}{d}_{11} & {d}_{12} & {d}_{13} & {d}_{14} \\ {d}_{21} & {d}_{22} & {d}_{23} & {d}_{24}\end{matrix} ) ( \begin{matrix}X \\ Y \\ Z \\ 1\end{matrix} ) \qquad Formula 3$$

Next, the controller 100 successively performs steps S25 to S27. At step S25, the second coordinate calculator 126 performs image processing to calculate two-dimensional coordinates of each point on the second irradiation lines L2 in the two-dimensional image. At step S26, based on the second irradiation angle θ2 and based on the two-dimensional coordinates of each point on the second irradiation lines L2, the second coordinate calculator 126 calculates three-dimensional coordinates of each point on the second irradiation lines L2. At step S27, the second coordinate calculator 126 accumulates the calculated three-dimensional coordinates in the coordinate accumulator 127.

Based on the principle of triangulation, the second coordinate calculator 126 calculates three-dimensional coordinates X, Y, and Z from Formulae (1) and (3), for example. The three-dimensional coordinates X, Y, and Z are calculated by solving simultaneous equations including an equation acquired by substituting two-dimensional coordinates u and v into Formula (1), and an equation acquired by substituting the second irradiation angles θ2 into Formula (3).

Next, the controller 100 performs step S28. At step S28, the irradiation controller 121 confirms whether the second irradiation line L2 has been moved to an end of the measurement range.

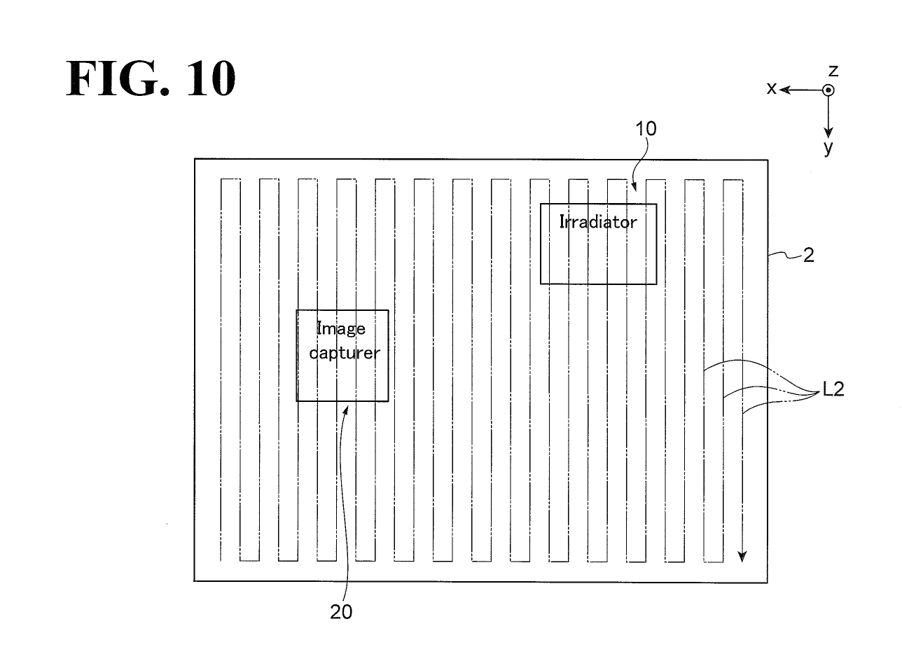

When at step S28 the irradiation controller 121 confirms that the second irradiation line L2 has not been moved to the end of the measurement range, the controller 100 performs step S29. At step S29, the irradiation controller 121 controls the MEMS mirror 41 to change the second irradiation angle θ2. Specifically, the irradiation controller 121 controls the MEMS mirror 41 to slightly increase or slightly decrease the second irradiation angle θ2. After changing the second irradiation angle θ2, the controller 100 returns the processing to step S21, and repeats steps S21 to S29 until the second irradiation line L2 is moved to the end of the measurement range. Thus, the plurality of second irradiation lines L2 are irradiated with the laser beam (see FIG. 10) respectively at the plurality of second irradiation angles θ2, and three-dimensional coordinates of the irradiation spots are calculated and accumulated. The controller 100 may repeat steps S21 to S29 for each frame period described above.

Thus, the method for measurement according to this embodiment includes: irradiating the plurality of second irradiation lines L2 with the laser beam respectively at the plurality of second irradiation angles θ2; identifying three-dimensional coordinates of intersection points at which the plurality of second irradiation lines L2 intersect at least one first irradiation line L1 among the plurality of first irradiation lines L1 based on two-dimensional coordinates of the intersection points; calculating the plurality of second irradiation angles θ2 based on the three-dimensional coordinates of the intersection points; and calculating three-dimensional coordinates of points on the plurality of second irradiation lines L2 based on the plurality of second irradiation angles θ2 and based on the two-dimensional coordinates of the points on the plurality of second irradiation lines L2.

When at step S28 the irradiation controller 121 confirms that the second irradiation line L2 has been moved to the end of the measurement range, the controller 100 performs step S31. At step S31, based on the data accumulated in the coordinate accumulator 127, the image generator 128 generates an image of a surface shape of the measured object W.

Thus, the control and arithmetic processing by the controller 100 is completed. It is noted that the order of steps S11 to S30 is suitably changeable as follows. In the above-described procedure, each time a two-dimensional image on the first irradiation line L1 is acquired, three-dimensional coordinates of a point on the first irradiation line L1 are calculated. Another possible embodiment is that after all two-dimensional images of the plurality of first irradiation lines L1 have been acquired, three-dimensional coordinates of the points on the first irradiation lines L1 are calculated. In the above-described procedure, each time a two-dimensional image on the second irradiation line L2 is acquired, three-dimensional coordinates of a point on the second irradiation line L2 are calculated. Another possible embodiment is that after all two-dimensional images of the plurality of second irradiation lines L2 have been acquired, three-dimensional coordinates of the points on the second irradiation lines L2 may be calculated.

4. Advantageous Effects of Measurement System According to this Embodiment

As described above, the measurement system 1 includes the irradiator 10, the image capturer 20, and the arithmetic processor (controller 100). The irradiator 10 irradiates the first irradiation line L1 with the laser beam LB1 at the predetermined first irradiation angle θ1, and irradiates the plurality of second irradiation lines L2, which intersect the first irradiation line L1, with the laser beam LB2 respectively at the plurality of second irradiation angles θ2. The image capturer 20 acquires a two-dimensional image of the area R1, which includes the first irradiation line L1 and the plurality of second irradiation lines L2. The arithmetic processor calculates the plurality of second irradiation angles θ2 based on the first irradiation angle θ1, based on two-dimensional coordinates of points on the first irradiation line L1, and based on two-dimensional coordinates of points on the plurality of second irradiation lines L2. The arithmetic processor calculates three-dimensional coordinates of the points on the plurality of second irradiation lines L2 based on the plurality of second irradiation angles θ2 and based on the two-dimensional coordinates of the points on the plurality of second irradiation lines L2.

The method for measurement performed by the measurement system 1 includes: irradiating the first irradiation line L1 with the laser beam LB1 at the predetermined first irradiation angle θ1; irradiating the plurality of second irradiation lines L2, which intersect the first irradiation line L1, with the laser beam LB2 respectively at the plurality of second irradiation angles θ2; acquiring a two-dimensional image of an area including the first irradiation line L1 and the plurality of second irradiation lines L2; calculating the plurality of second irradiation angles θ2 based on the first irradiation angle θ1, based on two-dimensional coordinates of points on the first irradiation line L1, and based on two-dimensional coordinates of points on the plurality of second irradiation lines L2; and calculating three-dimensional coordinates of the points on the plurality of second irradiation lines L2 based on the plurality of second irradiation angles θ2 and based on the two-dimensional coordinates of the points on the plurality of second irradiation lines L2.

In the measurement system and the method for measurement, the second irradiation angles θ2 are calculated based on the predetermined first irradiation angle θ1, based on two-dimensional coordinates of points on the first irradiation line L1, and based on two-dimensional coordinates of points on the second irradiation lines L2. Based on the second irradiation angles θ2 and based on the two-dimensional coordinates of the points on the second irradiation lines L2, three-dimensional coordinates of the points on the second irradiation lines L2 are calculated. The second irradiation angles θ2 and the two-dimensional coordinates of the points on the second irradiation lines L2 are acquired from a two-dimensional image. Hence, information concerning the second irradiation angles θ2 and information concerning the two-dimensional coordinates of the points on the second irradiation lines L2 are inherently synchronized with each other. The inherent synchronization eliminates the need for an adjustment for synchronizing the pieces of information. This configuration facilitates measurement of three-dimensional coordinates of the surface of the measured object W.

Thus, the information concerning the second irradiation angles θ2 is reliably synchronized with the information concerning the two-dimensional coordinates of the points on the second irradiation lines L2. The reliable synchronization contributes to an improvement in accuracy. Moreover, since the second irradiation angles θ2 are acquired from a two-dimensional image, it is not necessary to use an angle sensor to measure the second irradiation angles θ2. Acquiring the second irradiation angles from a two-dimensional image simplifies the configuration of the measurement system 1.

The irradiator 10 irradiates the plurality of first irradiation lines L1 with the laser beam LB1. Based on two-dimensional coordinates of intersection points at which the plurality of second irradiation lines L2 intersect at least one first irradiation line L1 among the plurality of first irradiation lines L1, the controller 100 calculates the plurality of second irradiation angles θ2. There is a possibility of the first irradiation line L1 partially blocked by the measured object W, making the blocked part unable to be irradiated with the laser beam LB1. The presence of the un-irradiated part may make it impossible or difficult to acquire two-dimensional coordinates of the intersection point of the first irradiation line L1 and the second irradiation line L2. Even in this case, this embodiment ensures that the second irradiation angle θ2 is calculated based on two-dimensional coordinates of an intersection point of another first irradiation line L1 and the second irradiation line L2. This configuration minimizes the area in which it is impossible or difficult to calculate three-dimensional coordinates. There is no limitation to the method of irradiating the plurality of first irradiation lines L1 with the laser beam LB1. For example, instead of changing the first irradiation angle θ1, the position for emitting the laser beam LB1 may be changed.

The irradiator 10 includes the light source 30, the MEMS mirror 41, and the irradiation controller 121. The light source 30 emits a laser beam. The MEMS mirror 41 reflects the laser beam emitted from the light source 30. The irradiation controller 121 turns the MEMS mirror 41 to irradiate the plurality of second irradiation lines L2 with the laser beam, reflected by the MEMS mirror 41, respectively at the plurality of second irradiation angles θ2. When a MEMS mirror is employed as a tunable mirror, it may be difficult to increase the measurement accuracy of the turning angle of the mirror. This situation makes it even more meaningful to acquire the second irradiation angles θ2 from a two-dimensional image.

The light source 30 emits a spotted laser beam. The MEMS mirror 41 turns about the two axes L21 and L22, which intersect each other. The irradiation controller 121 turns the MEMS mirror 41 to irradiate the plurality of second irradiation lines L2 with the laser beam, reflected by the MEMS mirror 41, respectively at the plurality of second irradiation angles θ2. The irradiation controller 121 turns the MEMS mirror 41 to move an irradiation spot made by the laser beam along the plurality of second irradiation lines L2. Thus, even though a spotted laser beam is used, a wide area of the second irradiation lines L2 is irradiated with the laser beam. This configuration eliminates the need for an optical device to widen the laser beam into a slit shape, resulting in a simplified configuration of the light source 30.

The irradiator 10 moves the irradiation spot made by the laser beam along the first irradiation lines L1 or the second irradiation lines L2 during the exposure by the image capture device 22 of the image capturer 20. This configuration ensures that images of a plurality of irradiation spots along a single first irradiation line L1 are concentrated in a single two-dimensional image, and that images of a plurality of irradiation spots along a single second irradiation line L2 are concentrated in a single two-dimensional image. This ensures contributions such as an improvement in the measurement speed and a reduction in the storage capacity for two-dimensional images. It is noted that acquiring two-dimensional images in this manner should not be construed in a limiting sense. Another possible embodiment is to acquire a single two-dimensional image for each irradiation spot.

The irradiation controller 121 turns the MEMS mirror 41 to irradiate the first irradiation line L1 with the laser beam, reflected by the MEMS mirror 41, at the first irradiation angle θ1 and to move an irradiation spot made by the laser beam along the first irradiation line L1. Thus, use of a pair made up of the light source 30 and the MEMS mirror 41 suffices in irradiating both the first irradiation line L1 and the second irradiation lines L2 with the laser beam. This configuration simplifies the configuration of the measurement system 1.

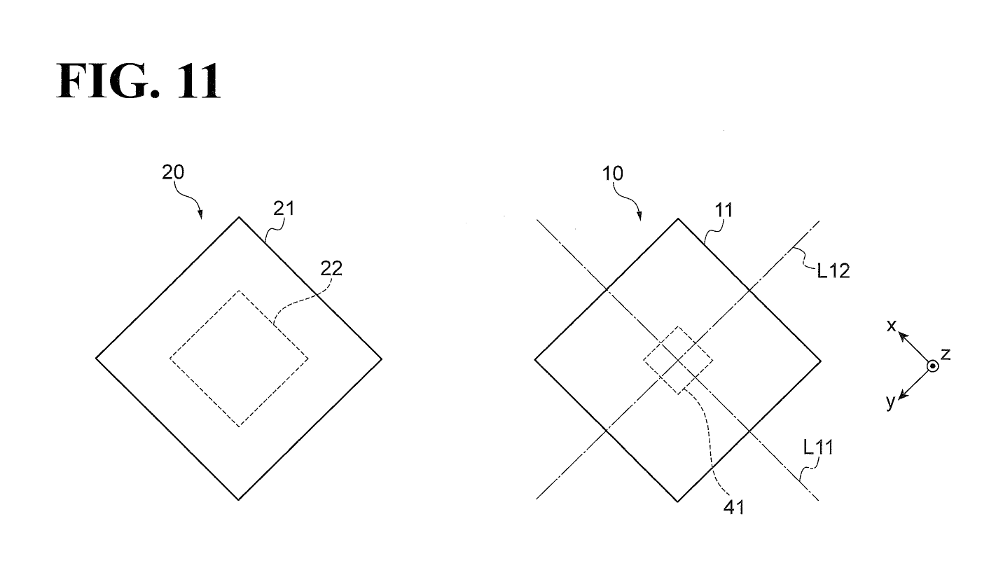

The first irradiation angle θ1 is an angle around the first axis L11, and the second irradiation angle θ2 is an angle around the second axis L12. The image capture device 22 and the MEMS mirror 41 are aligned in a direction inclined relative to the first axis L11 and the second axis L12 (see FIG. 11). The triangulation using the first irradiation angle θ1 and the two-dimensional image requires the distance between the emission position of the laser beam LB1 at the first irradiation angle θ1 and the image capture position of the two-dimensional image (this distance will be hereinafter referred to as “first base length”). The triangulation using the second irradiation angle θ2 and the two-dimensional image requires the distance between the emission position of the laser beam LB2 at the second irradiation angle 82 and the image capture position of the two-dimensional image (this distance will be hereinafter referred to as “second base length”). Aligning the image capture device 22 and the MEMS mirror 41 in the direction inclined relative to the first axis L11 and the second axis L12 secures the first base length and the second base length.

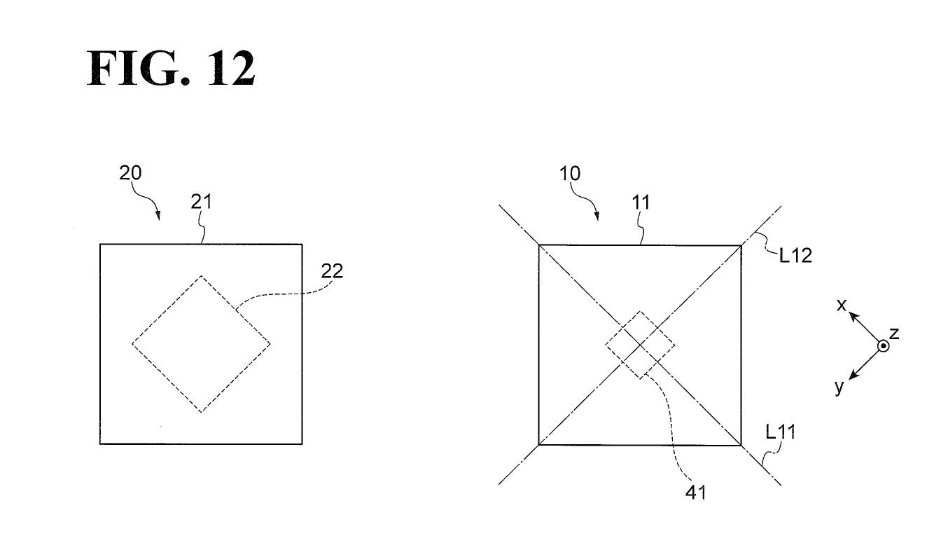

The image capturer 20 may further include a casing 21 to accommodate the image capture device 22. As illustrated in FIG. 12, the casing 21 may have a rectangular shape in the direction in which the image capture device 22 and the MEMS mirror 41 are aligned, as seen in a direction orthogonal to the first axis L11 and the second axis L12. The image capture device 22 may have a rectangular shape inclined relative to the casing 21, as seen in the direction orthogonal to the first axis L11 and the second axis L12. Arranging the casing 21 in the direction in which the image capture device 22 and the MEMS mirror 41 are aligned eliminates or minimizes the dead space between the image capturer 20 and the irradiator 10. Eliminating or minimizing the dead space minimizes the size of the measurement system 1. Arranging the image capture device 22 in an inclined manner relative to the casing 21 makes the first irradiation line L1 aligned with two sides of the image capture device 22 and makes the second irradiation line L2 aligned with the other two sides of the image capture device 22. This configuration ensures that the second irradiation line L2, which intersects the first irradiation line L1, covers a wide area of the two-dimensional image. This enables a wide area of the two-dimensional image to be used to calculate three-dimensional coordinates, resulting in an enlarged area available for calculation of three-dimensional coordinates.

The irradiator 10 may further include a casing 11 to accommodate the light source 30 and the MEMS mirror 41. The casing 11, similarly to the casing 21, may have a rectangular shape in the direction in which the image capture device 22 and the MEMS mirror 41 are aligned, as seen in the direction orthogonal to the first axis L11 and the second axis L12. This configuration as well eliminates or minimizes the dead space between the image capturer 20 and the irradiator 10, resulting in a minimized size of the measurement system 1.

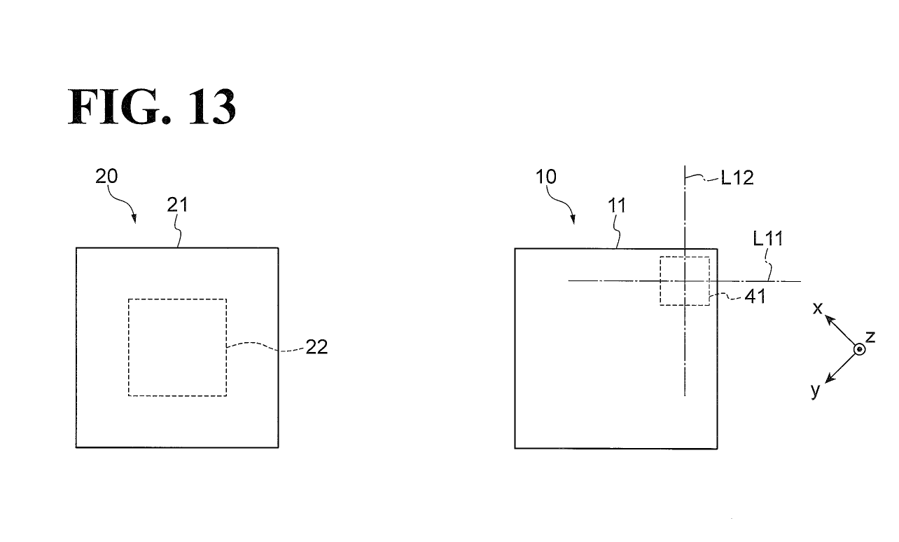

As illustrated in FIG. 13, as seen in the direction orthogonal to the first axis L11 and the second axis L12, the casing 21 and the casing 11 may be aligned along the first axis L11 and the second axis L12. The casing 21 and the casing 11 may have rectangular shapes along the first axis L11 and the second axis L12. The image capture device 22 and the MEMS mirror 41 may be displaced from each other in a direction orthogonal to the direction in which the casing 21 and the casing 11 are aligned. In this case as well, aligning the casing 21 and the casing 11 eliminates or minimizes the dead space between the irradiator 10 and the image capturer 20, resulting in a minimized size of the measurement system 1. Additionally, since the direction in which the image capture device 22 and the MEMS mirror 41 are aligned is inclined relative to the first axis L11 and the second axis L12. This configuration ensures that the first base length and the second base length are secured.

The irradiator 10 will not be limited to the above-described configuration insofar as the irradiator irradiates the first irradiation line L1 with the laser beam LB1 at the predetermined first irradiation angle θ1 and irradiates the plurality of second irradiation lines L2, which intersect the first irradiation line L1, with the laser beam LB2 respectively at the plurality of second irradiation angles θ2.

As described above, including the MEMS mirror 41 into the configuration of the irradiator 10 makes it even more meaningful to acquire the second irradiation angles θ2 from a two-dimensional image. This configuration, however, should not be construed in a limiting sense. Another possible embodiment is that the irradiator 10 includes a mirror other than a MEMS mirror. Specifically, the irradiator 10 may include the light source 30, a mirror, and the irradiation controller 121. The light source 30 emits a spotted laser beam. The mirror reflects the laser beam emitted from the light source 30. The mirror turns about two axes intersecting each other. The irradiation controller 121 turns the mirror to irradiate the plurality of second irradiation lines with the laser beam, reflected by the mirror, respectively at the plurality of second irradiation angles, and to move an irradiation spot made by the laser beam along the plurality of second irradiation lines. In this case as well, even though a spotted laser beam is used, a wide area of the second irradiation lines L2 is irradiated with the laser beam. This configuration eliminates the need for an optical device to widen the laser beam into a slit shape, resulting in a simplified configuration of the light source 30.

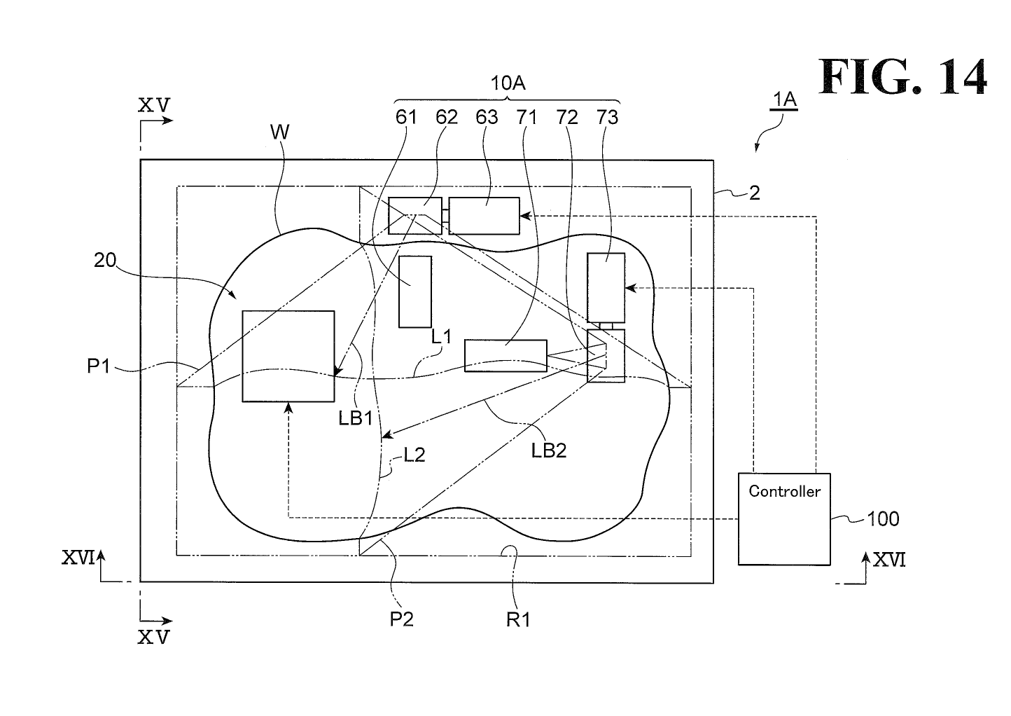

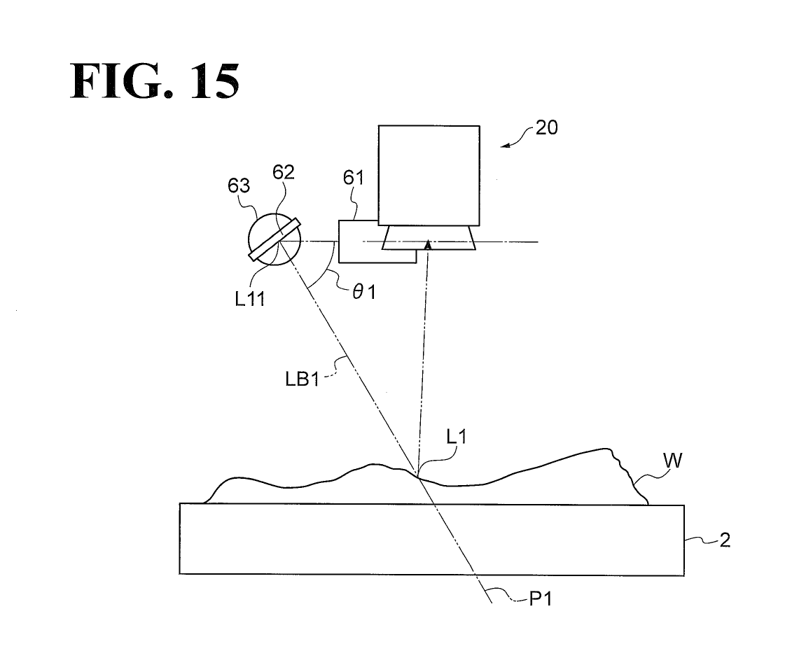

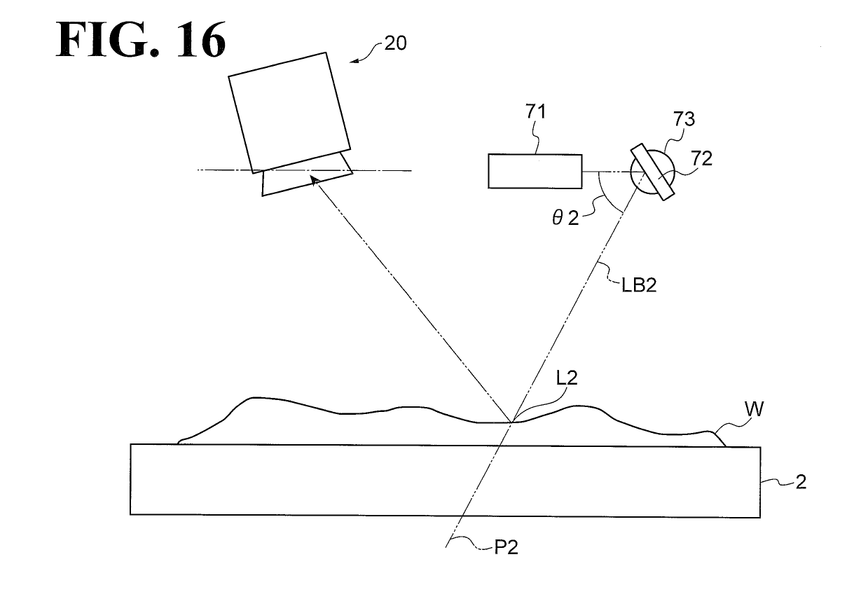

In the irradiator 10, a single optical system is used to irradiate the first irradiation line L1 and the second irradiation line L2 with a spotted laser beam. Although this configuration contributes to simplifying the configuration of the measurement system 1, the spotted form of the laser beam emitted to the first irradiation line L1 and the second irradiation line L2 should not be construed in a limiting sense. Also, the use of a single optical device to emit the laser beams LB1 and LB2 should not be construed in a limiting sense. FIGS. 14 to 16 illustrate a measurement system 1A. In the measurement system 1A, an irradiator 10A includes a first light source 61, a first mirror 62, a first motor 63, a second light source 71, a second mirror 72, and a second motor 73. The first light source 61, the first mirror 62, and the first motor 63 are dedicated to the laser beam LB1. The second light source 71, the second mirror 72, and the second motor 73 dedicated to the laser beam LB2.

The first light source 61 emits a slit laser beam. The first mirror 62 is arranged to reflect the laser beam emitted from the first light source 61 and to make the laser beam reach the first irradiation line L1 through an optical path along a first plane P1. The first motor 63 turns the first mirror 62 to irradiate the plurality of first irradiation lines L1 with the laser beam, reflected by the first mirror 62, respectively at the plurality of first irradiation angles θ1.

The second light source 71 emits a slit laser beam. The second mirror 72 is arranged to reflect the laser beam emitted from the second light source 71 and to make the laser beam reach the second irradiation line L2 through an optical path along a second plane P2. The second motor 73 turns the second mirror 72 to irradiate the plurality of second irradiation lines L2 with the laser beam, reflected by the second mirror 72, respectively at the plurality of second irradiation angles θ2.

With this configuration as well, the second irradiation angles θ2 and two-dimensional coordinates of points on the second irradiation lines L2 are acquired from a two-dimensional image. Hence, information concerning the second irradiation angles θ2 and information concerning the two-dimensional coordinates of the points on the second irradiation lines L2 are inherently synchronized with each other. The inherent synchronization eliminates the need for an adjustment for synchronizing the pieces of information. This configuration facilitates measurement of three-dimensional coordinates of the surface of the measured object W.

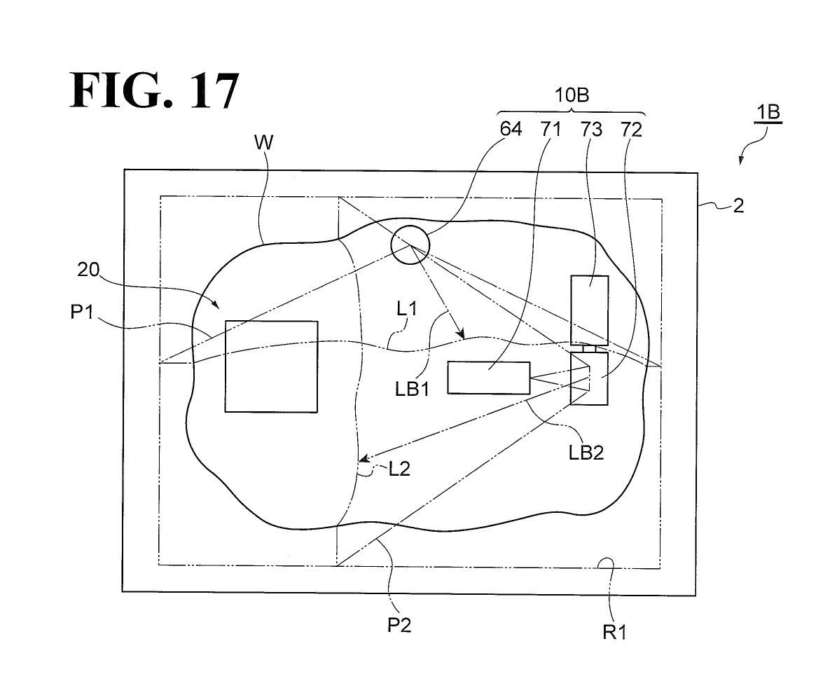

As described above, irradiating the plurality of first irradiation lines L1 with the laser beam contributes to minimizes the area in which it is impossible or difficult to calculate three-dimensional coordinates. This configuration, however, should not be construed in a limiting sense. FIG. 17 illustrates a measurement system 1B. In the measurement system 1B, an irradiator 10B includes a first light source 64 in place of the first light source 61, the first mirror 62, and the first motor 63 of the irradiator 10A. The first light source 64 irradiates a single first irradiation line L1 with a slit laser beam at a single predetermined first irradiation angle θ1. The first light source 64 directly irradiates the first irradiation line L1 with the laser beam, without the intermediation of a mirror.

As illustrated in FIG. 17, the intermediation of a mirror along the optical path from the light source to the first irradiation line L1 is not essential. The intermediation of a mirror along the optical path from the light source to the second irradiation line L2 is not essential, either. Even in the case of directly irradiating the first irradiation line L1 or the second irradiation line L2 with the laser beam from the light source, the irradiation angle is changeable by turning the light source.

### 5. Modification of Measurement System

The present disclosure should not be limited to the above-described embodiments. Any other measurement system is possible insofar as the measurement system at least includes an irradiator, an image capturer, and an arithmetic processor. The irradiator emits a laser beam. The image capturer acquires a two-dimensional image of an area including irradiation spots made by the laser beam. The arithmetic processor calculates three-dimensional coordinates of the irradiation spots made by the laser beam based only on known information and information acquired from the two-dimensional image. Various other modifications are possible within the scope of the present disclosure.

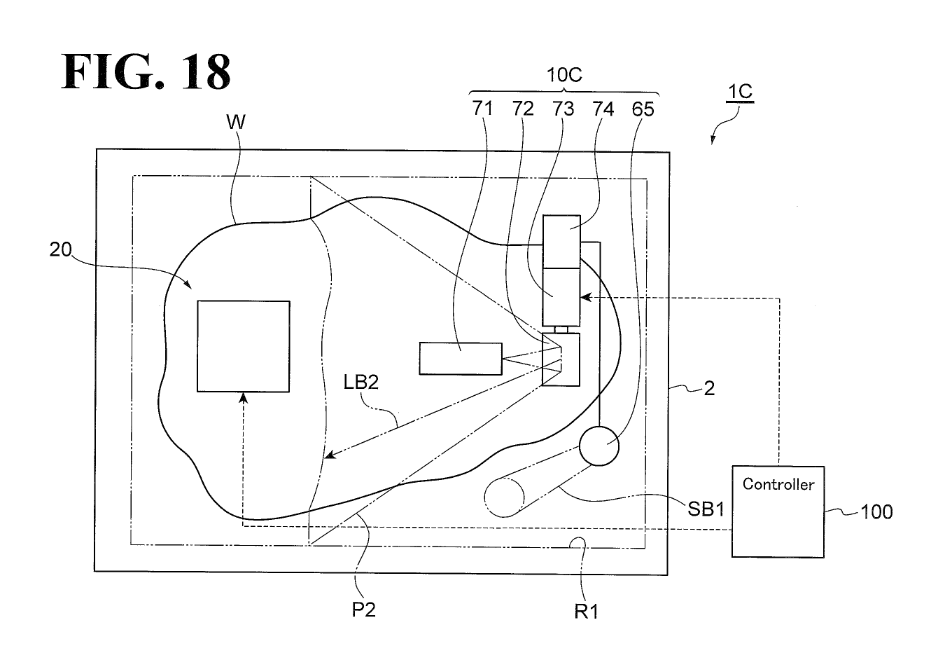

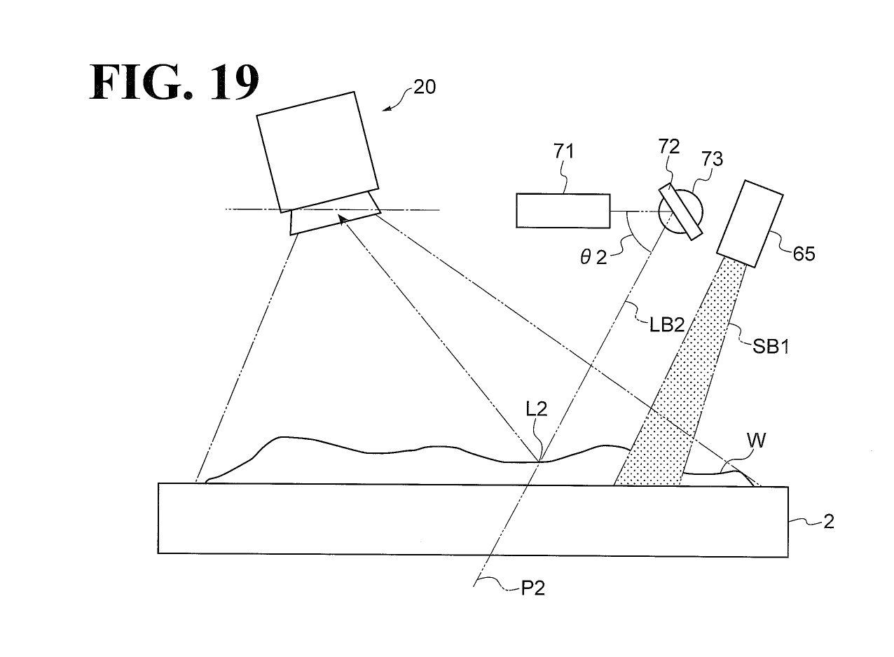

FIGS. 18 and 19 illustrate a measurement system 1C. In the measurement system 1C, an irradiator 10C includes the irradiator 10B with an angle sensor 74, and a light source 65 in place of the first light source 64. A non-limiting example of the angle sensor 74 is an encoder to detect the second irradiation angles θ2. The light source 65 emits an auxiliary beam SB1. The auxiliary beam SB1 indicates information concerning the second irradiation angle θ2 detected by the angle sensor 74. That is, the irradiator 10C emits not only the laser beam LB2 but also the auxiliary beam SB1, which indicates information concerning the second irradiation angle θ2.

The auxiliary beam SB1 may be any beam insofar as the beam is light of information that, when emitted to the area R1, indicates the second irradiation angles θ2 and is recognizable by image processing. Examples of the auxiliary beam SB1 include, but are not limited to, a beam to project text information concerning the second irradiation angles θ2 into the area R1, a beam to project color information concerning the second irradiation angles θ2 into the area R1, and a beam to project brightness information concerning the second irradiation angles θ2 into the area R1. It is noted that the laser beam LB1, described above, is an example of the auxiliary beam SB1. When the laser beam LB1 is used as the auxiliary beam SB1, the angle sensor 74 is not necessary.

The image capturer 20 acquires a two-dimensional image of the area R1, which includes irradiation spots made by the laser beam LB2 and the auxiliary beam SB1. A controller 100C functions as a controller for the irradiator 10C and the image capturer 20. The controller 100C also functions as an arithmetic processor to calculate three-dimensional coordinates. As the arithmetic processor, the controller 100C acquires the second irradiation angles θ2 based on the irradiation spots made by the auxiliary beam SB1 in the two-dimensional image. Based on the second irradiation angles θ2 and two-dimensional coordinates of the irradiation spots made by the laser beam LB2, the controller 100C calculates three-dimensional coordinates of the irradiation spots made by the laser beam LB2.

With this configuration as well, the second irradiation angles θ2 and the two-dimensional coordinates of the irradiation spot made by the laser beam LB2 are acquired from a two-dimensional image. Hence, information concerning the second irradiation angles θ2 and information concerning the two-dimensional coordinates of the irradiation spot made by the laser beam LB2 are inherently synchronized with each other. The inherent synchronization eliminates the need for an adjustment for synchronizing the pieces of information. This configuration facilitates measurement of three-dimensional coordinates of the surface of the measured object W.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A measurement system comprising:
an irradiator configured to irradiate a first irradiation line with a laser beam at a predetermined first irradiation angle, and configured to irradiate a plurality of second irradiation lines with the laser beam respectively at a plurality of second irradiation angles, the plurality of second irradiation lines intersecting the predetermined first irradiation line;
an image capturer configured to acquire a two-dimensional image of an area comprising the predetermined first irradiation line and the plurality of second irradiation lines; and
an arithmetic processor configured to calculate the plurality of second irradiation angles based on the first irradiation angle, based on a first position, in the two-dimensional image, of a first point on the predetermined first irradiation line, and based on second positions, in the two-dimensional image, of second points of the plurality of second irradiation lines, and configured to calculate three-dimensional coordinates of the second points based on the plurality of second irradiation angles and based on the second positions.

2. The measurement system according to claim 1,
wherein the predetermined first irradiation line comprises a plurality of predetermined first irradiation lines, and the irradiator is configured to irradiate the plurality of predetermined first irradiation lines with the laser beam, and
wherein the arithmetic processor is configured to calculate the plurality of second irradiation angles based on third positions, in the two-dimensional image, of third points at which the plurality of second irradiation lines intersect at least one first irradiation line among the plurality of first irradiation lines.

3. The measurement system according to claim 1, wherein the irradiator comprises
a light source configured to emit the laser beam,
a MEMS mirror to reflect the laser beam emitted from the light source, and
an irradiation controller configured to turn the MEMS mirror to irradiate the plurality of second irradiation lines with the laser beam, reflected by the MEMS mirror, respectively at the plurality of second irradiation angles.

4. The measurement system according to claim 3,
wherein the laser beam emitted from the light source comprises a spotted laser beam,
wherein the MEMS mirror is turnable about two axes intersecting each other, and
wherein the irradiation controller is configured to turn the MEMS mirror to irradiate the plurality of second irradiation lines with the spotted laser beam, reflected by the MEMS mirror, respectively at the plurality of second irradiation angles so as to move a first irradiation spot made by the spotted laser beam along the plurality of second irradiation lines.

5. The measurement system according to claim 4, wherein the irradiation controller is configured to turn the MEMS mirror to irradiate the predetermined first irradiation line with the spotted laser beam, reflected by the MEMS mirror, at the first irradiation angle, and configured to move a second irradiation spot made by the spotted laser beam along the predetermined first irradiation line.

6. The measurement system according to claim 3,
wherein the first irradiation angle comprises an angle around a first axis,
wherein the second irradiation angle comprises an angle around a second axis, and
wherein the image capturer comprises an image capture device, the image capture device and the MEMS mirror being aligned in a direction inclined relative to the first axis and the second axis.

7. The measurement system according to claim 6,
wherein the image capturer comprises a casing accommodating the image capture device,
wherein as seen in a direction orthogonal to the first axis and the second axis, the casing comprises a rectangular shape extending in the direction in which the image capture device and the MEMS mirror are aligned, and
wherein as seen in the direction orthogonal to the first axis and the second axis, the image capture device comprises a rectangular shape inclined relative to the casing.

8. The measurement system according to claim 1, wherein the irradiator comprises
a light source configured to emit a spotted laser beam,
a mirror to reflect the spotted laser beam emitted from the light source, the mirror being turnable about two axes intersecting each other, and
an irradiation controller configured to turn the mirror to irradiate the plurality of second irradiation lines with the laser beam, reflected by the mirror, respectively at the plurality of second irradiation angles so as to move an irradiation spot made by the spotted laser beam along the plurality of second irradiation lines.

9. A measurement system comprising:
an irradiator configured to emit a laser beam;
an image capturer configured to acquire a two-dimensional image of a first area comprising a first irradiation spot made by the laser beam; and
an arithmetic processor configured to calculate three-dimensional coordinates of the first irradiation spot based on known information and information acquired from the two-dimensional image.

10. The measurement system according to claim 9,
wherein the irradiator is configured to emit the laser beam and configured to emit an auxiliary beam indicating information concerning an irradiation angle of the laser beam,
wherein the image capturer is configured to acquire a two-dimensional image of a second area comprising the first irradiation spot and a second irradiation spot made by the auxiliary beam, and
wherein the arithmetic processor is configured to acquire the irradiation angle of the laser beam based on the second irradiation spot in the two-dimensional image, and configured to calculate three-dimensional coordinates of the first irradiation spot based on the irradiation angle and based on a position, in the two-dimensional image, of the first irradiation spot.

11. A method for measurement, the method comprising:
irradiating a first irradiation line with a laser beam at a predetermined first irradiation angle and irradiating a plurality of second irradiation lines with the laser beam respectively at a plurality of second irradiation angles, the plurality of second irradiation lines intersecting the predetermined first irradiation line;
acquiring a two-dimensional image of an area comprising the predetermined first irradiation line and the plurality of second irradiation lines; and
calculating the plurality of second irradiation angles based on the first irradiation angle, based on a first position, in the two-dimensional image, of a first point on the predetermined first irradiation line, and based on second positions, in the two-dimensional image, of second points of the plurality of second irradiation lines, and calculating three-dimensional coordinates of the second points based on the plurality of second irradiation angles and based on the second positions.

12. The measurement system according to claim 2, wherein the irradiator comprises
a light source configured to emit the laser beam,
a MEMS mirror to reflect the laser beam emitted from the light source, and
an irradiation controller configured to turn the MEMS mirror to irradiate the plurality of second irradiation lines with the laser beam, reflected by the MEMS mirror, respectively at the plurality of second irradiation angles.

13. The measurement system according to claim 12,
wherein the laser beam emitted from the light source comprises a spotted laser beam,
wherein the MEMS mirror is turnable about two axes intersecting each other, and
wherein the irradiation controller is configured to turn the MEMS mirror to irradiate the plurality of second irradiation lines with the spotted laser beam, reflected by the MEMS mirror, respectively at the plurality of second irradiation angles so as to move a first irradiation spot made by the spotted laser beam along the plurality of second irradiation lines.

14. The measurement system according to claim 13, wherein the irradiation controller is configured to turn the MEMS mirror to irradiate the predetermined first irradiation line with the spotted laser beam, reflected by the MEMS mirror, at the first irradiation angle, and configured to move a second irradiation spot made by the spotted laser beam along the predetermined first irradiation line.

15. The measurement system according to claim 4,
wherein the first irradiation angle comprises an angle around a first axis,
wherein the second irradiation angle comprises an angle around a second axis, and
wherein the image capturer comprises an image capture device, the image capture device and the MEMS mirror being aligned in a direction inclined relative to the first axis and the second axis.

16. The measurement system according to claim 5,
wherein the first irradiation angle comprises an angle around a first axis,
wherein the second irradiation angle comprises an angle around a second axis, and
wherein the image capturer comprises an image capture device, the image capture device and the MEMS mirror being aligned in a direction inclined relative to the first axis and the second axis.

17. The measurement system according to claim 12,
wherein the first irradiation angle comprises an angle around a first axis,
wherein the second irradiation angle comprises an angle around a second axis, and
wherein the image capturer comprises an image capture device, the image capture device and the MEMS mirror being aligned in a direction inclined relative to the first axis and the second axis.

18. The measurement system according to claim 13,
wherein the first irradiation angle comprises an angle around a first axis,
wherein the second irradiation angle comprises an angle around a second axis, and
wherein the image capturer comprises an image capture device, the image capture device and the MEMS mirror being aligned in a direction inclined relative to the first axis and the second axis.

19. The measurement system according to claim 14,
wherein the first irradiation angle comprises an angle around a first axis,
wherein the second irradiation angle comprises an angle around a second axis, and
wherein the image capturer comprises an image capture device, the image capture device and the MEMS mirror being aligned in a direction inclined relative to the first axis and the second axis.

20. The measurement system according to claim 15,
wherein the image capturer comprises a casing accommodating the image capture device,
wherein as seen in a direction orthogonal to the first axis and the second axis, the casing comprises a rectangular shape extending in the direction in which the image capture device and the MEMS mirror are aligned, and
wherein as seen in the direction orthogonal to the first axis and the second axis, the image capture device comprises a rectangular shape inclined relative to the casing.
